(19) United States
(12) Patent Application Publication
(10) Pub. No.: US 2021/0064871 A1
(43) Pub. Date: Mar. 4, 2021

(54) APPARATUS AND METHOD FOR RECOGNITION OF TEXT INFORMATION

(71) Applicant: LG ELECTRONICS INC., Seoul (KR)

(72) Inventors: Youngho SOHN, Seoul (KR); Young Yeon SEO, Seoul (KR); Changjun YEO, Seoul (KR)

(73) Assignee: LG ELECTRONICS INC., Seoul (KR)

(21) Appl. No.: 16/809,390

(22) Filed: Mar. 4, 2020

(30) Foreign Application Priority Data
Aug. 27, 2019 (KR) 10-2019-0105040

(51) Int. Cl. G06K 9/00; G06K 9/20; G06K 9/46; G06F 3/0482; G06K 9/62

(52) U.S. Cl. CPC G06K 9/00664; G06K 9/2054; G06K 2209/01; G06F 3/0482; G06K 9/6265; G06K 9/4604

(57) ABSTRACT

A text recognition method and apparatus is disclosed. A text recognition method includes detecting the width and the location of a digit through segmentation using a grid having a variable width. According to the present disclosure, it is possible to distinguish an embossing text and a printing text through a 5G network service and a neural network (CNN) performing deep learning, and to recognize a card number through different methods for each card type.

### CROSS-REFERENCE TO RELATED APPLICATION

Pursuant to 35 U.S.C. § 119(a), this application claims the benefit of earlier filing date and right of priority to Korean Patent Application No. 10-2019-0105040, filed on Aug. 27, 2019, the contents of which are hereby incorporated by reference herein in its entirety.

### BACKGROUND

### 1. Technical Field

The present disclosure relates to a text recognition apparatus and method, and more particularly, to an apparatus and a method for reading text information by recognizing a text on an object, for example, various cards including a credit card.

### 2. Description of Related Art

In the online payment market where payments using personal computers (PCs) were the main, mobile payments using a mobile terminal so called a smartphone are rapidly increasing.

A payment method using NFC and a payment application is largely used as a mobile payment method using the smartphone. The use of the payment method using near field communication (NFC) is limited due to the lack of the spread of NFC readers in stores.

Meanwhile, in the payment method using the payment application, a payment can be easily performed by storing the card information including the credit card number to be used for payment in advance in the smartphone and inputting a password at payment.

Even if the card information is stored in the smartphone and used at payment, the card information should be input and stored in the smartphone. Due to the characteristics of the smart phone according to the pursuit of the user's comfortable interface, various card number recognition methods have been studied according to the need of a card information input method by a simple procedure.

Traditional optical character recognition (OCR) is an automatic recognition solution for converting texts and images on prints into digital data. The OCR, however, is not suitable for the recognition of the text that is embossed, because the recognition rate is very low.

An embossed credit card number, unlike plain text, is difficult to be distinguished from background and contrast. Many credit cards are decorated with various images in the background, making it difficult to identify the number in many cases. It is difficult to identify the number because the gold or silver foil on the number is peeled off. Since the credit card is made of plastic, light may be reflected on its surface. Further, there is also a case where different standard fonts are used according to a credit card issuer.

According to the characteristics of the credit card, the embossed credit card number may not be recognized by the ordinary text optical character recognition (OCR) technology, and a separate image processing number recognition technology for embossed text image is required.

Further, the related art is limited to 16-digit fixed form and card number recognition in predetermined positions, and accordingly, is not suitable for recognizing numbers in various types of card.

As one related art, a credit card number recognition system using the area characteristic of a card number is disclosed in the Korean Patent No. 10-1295000. According to this related technology, the first four digits of the card number are recognized through the embossed number and the printed number, and the card number is determined by comparing the two recognized numbers. However, there is a problem in that the related art is limited to a card type in which an embossed number and a printed number are displayed at the same time, thereby narrowing the usage range.

Further, as another related art, a method for reading the expiration date of a payment card is disclosed in the Korean Patent No. 10-1880140. According to this related art, a significant figure is determined through a plurality of card images, and as the determination result, when the range of the same significant figure does not exceed 50%, the significant figure is recognized through an additional card image. However, according to the related art, there is a problem in that confusion may be added in specifying the significant figure according to the state of the card image.

### SUMMARY OF THE DISCLOSURE

An object of the present disclosure is to solve the problems of the related art, which used an OCR engine with a low recognition rate in order to recognize an embossed text.

Another object of the present disclosure is to solve the problems of the related art, which did not systematically distinguish and recognize the cards of the embossed and printed methods.

Still another object of the present disclosure is to provide a recognition method that may increase the recognition rate of the card number area by using a segmentation frame that has not been provided by the related art.

While this disclosure includes specific embodiments, it will be apparent to one of ordinary skill in the art that various changes in form and details may be made in these embodiments without departing from the spirit and scope of claims and their equivalents. The embodiments described herein are to be considered in a descriptive sense only, and not for purposes of limitation. Further, it is understood that the objects and advantages of the present disclosure may be embodied by the means and a combination thereof in claims.

A text recognition method of an embodiment of the present disclosure comprises recognizing a card number from a card image by performing vertical segmentation and horizontal segmentation, wherein the horizontal segmentation comprises detecting a width and a location of a digit of the card number through a segmentation using a grid having a variable width based on a configuration pattern of the card number including a size and a number of digits of the card number.

Further, the method may include performing a Luhn check, issuer identification number (IIN) check, a check based on multiple image frames sometimes referred to as a multi-frame check, and determining a prediction confidence of a convolutional neural network (CNN) based on a mean of confidence level values resulting from CNN recognition processing, sometimes referred to as a CNN mean confidence check.

In an embodiment, the method may include detecting a card area in a card image, wherein the detecting the card area comprises recognizing an edge of the card; and extracting the card area based on the recognized edge, wherein the recognizing the edge of the card comprises: analyzing a relationship between an upper edge and a lower edge of the card and a relationship between a left edge and a right edge of the card based on the card image; and determining the edge of the card based on the relationship analysis.

In an embodiment, an aspect ratio of the card in the card image is used for recognizing the edge of the card.

An embodiment of a text recognition method of the present disclosure comprises determining a text display method of a card from a card image, wherein the determining the text display method of the card comprises: determining at least whether the card image is of a front side or a rear side of the card according to presence of a card magnet in the card image, or whether the card image corresponds to a landscape or portrait orientation of the card based on a text array direction using a margin space calculation between texts; and predicting the text display method of the card based on the determination.

In an embodiment, determining the text display method of the card further comprises determining the text display method of the card between an embossing method and a printing method.

An embodiment of the present disclosure may further comprise recognizing a card number and an expiration date from the card image, wherein when it is determined that the text display method of the card is the embossing method, the recognizing the card number and the expiration date comprises: extracting information on at least a card company or an issuer through a card number recognition; detecting an expiration date type for a particular card company or issuer based on the extracted information and a previously stored database; and checking the expiration date by using the expiration date type.

An embodiment of the present disclosure may further comprise recognizing a card number and an expiration date from the card image, wherein when it is determined that the text display method of the card is the printing method, the recognizing the card number and the expiration date comprises: setting a candidate area based on the determination of whether the card image is of the front or rear side or whether the card image corresponds to the portrait or landscape orientation of the card; recognizing a text in the candidate area through an optical character recognition (OCR); and predicting the card number by using the recognized text and the expiration date based on a detected slash.

An embodiment may further comprise preprocessing the card image in order to recognize text overlapping an image background.

Another embodiment may further comprise displaying a menu for selecting a portrait type card or a landscape type card for processing a card image; and receiving an input card image according to the portrait type card or the landscape type card according to a user selection on the displayed menu.

In an embodiment of a text recognition apparatus of the present disclosure, the apparatus may comprise a camera; a display; and a processor configured to: capture a card image of a card via the camera and display the card image via the display; recognizing a card number of the card based on the card image, wherein the card number is recognized by performing vertical segmentation and horizontal segmentation, wherein the processor is further configured to detect a width and a location of a digit of the card number through vertical segmentation using a grid having a variable width based on a configuration pattern of the card number including a size and a number of digits of the card number.

In an embodiment, the processor is further configured to perform a Luhn algorithm check, issuer identification number (TIN) check, a Multi-frame check, and a CNN mean confidence check for the recognized card number.

In an embodiment of a text recognition apparatus of the present disclosure, the apparatus may comprise a camera; a display; and a processor configured to: capture a card image of a card via the camera and display the card image via the display; detect a card area using the card image by recognizing an edge of the card and extracting the card area based on the recognized edge; and wherein the processor is configured to recognize the edge of the card by analyzing a relationship between an upper edge and a lower edge of the card and a relationship between a left edge and a right edge of the card based on the card image, and wherein the processor is further configured to determine the edge of the card based on the relationship analysis.

In an embodiment, the processor is further configured to recognize the edge of the card by using an aspect ratio of the card in the card image.

In an embodiment of a text recognition apparatus of the present disclosure, the apparatus may comprise a camera; a display; and a processor configured to: capture a card image of a card via the camera and display the card image via the display; determine at least whether the card image is of a front side or a rear side of the card according to presence of a card magnet in the card image, or whether the card image corresponds to a landscape or portrait orientation of the card based on a text array direction using a margin space calculation between texts; and predict a text display method of a card based on the determination.

In an embodiment, the processor is further configured to determine the text display method of the card between an embossing method and a printing method.

In an embodiment, the processor is further configured to: extract information on at least a card company or an issuer through a card number recognition; detect an expiration date type for a particular card company or issuer based on the extracted information and a previously stored database; check an expiration date by using a database on an expiration date type for each card company and issuer previously prepared based on the recognized card number when the text display method of the card is determined to be the embossing method.

In another embodiment, the processor is further configured to: set a candidate area based on the determination of whether the card image is of the front or rear side or whether the card image corresponds to the portrait or landscape orientation of the card; recognize a text in the candidate area through an optical character recognition (OCR); and predict a card number by using the recognized text and an expiration date based on a detected slash.

In another embodiment, the processor is further configured to perform a card image preprocessing in order to recognize text overlapping an image background.

In an embodiment of the present disclosure, a text recognition apparatus comprises a camera; a display; and a processor configured to: display a menu via the display for selecting a portrait type card or a landscape type card for processing the card image; and receiving an input card image captured via the camera according to the portrait type card or the landscape type card according to a user selection on the displayed menu.

According to the present disclosure, it is possible to distinguish between the card of the embossed text and the card of the printed text, and to recognize the card number through different methods for each card type.

Further, it is possible to recognize both the card numbers of the embossed and printed methods according to the card type at a high recognition rate.

Further, it is possible to prevent a recognition error of the card number in advance by using information on card issuance.

### BRIEF DESCRIPTION OF THE DRAWINGS

FIG. 1 is an exemplary diagram of an embossed text display type card in which a text recognition method according to an embodiment of the present disclosure may be used.

FIG. 2 is an exemplary diagram of a network environment of a text recognition apparatus according to an embodiment of the present disclosure.

FIG. 3 is a block diagram of a terminal corresponding to the text recognition apparatus according to an embodiment of the present disclosure.

FIG. 4 is a block diagram of a memory according to an embodiment of the present disclosure.

FIG. 5 is a block diagram of a learning device according to an embodiment of the present disclosure.

FIG. 6 is a flowchart of the text recognition method according to an embodiment of the present disclosure.

FIG. 7 is an exemplary diagram of a card area detecting process according to an embodiment of the present disclosure.

FIG. 8 is an exemplary diagram of a card number area according to an embodiment of the present disclosure.

FIG. 9 is an exemplary diagram of a card number area according to an embodiment of the present disclosure.

FIG. 10 is an exemplary diagram of a card number vertical segmentation according to an embodiment of the present disclosure.

FIG. 11 is an exemplary diagram of a card number horizontal segmentation using a variable width grid according to an embodiment of the present disclosure.

FIG. 12 is an exemplary diagram of a score distribution according to the horizontal segmentation according to an embodiment of the present disclosure.

FIG. 13 is an exemplary diagram of a horizontal segmentation result according to an embodiment of the present disclosure.

FIG. 14 is an exemplary diagram of each digit of the text recognized according to an embodiment of the present disclosure.

FIG. 15 is an exemplary diagram of text recognition using an artificial intelligence model according to an embodiment of the present disclosure.

FIG. 16 is an exemplary diagram of a process for recognizing an expiration date according to an embodiment of the present disclosure.

FIG. 17 is an exemplary diagram of a process for recognizing a card having the printed text according to an embodiment of the present disclosure.

### DETAILED DESCRIPTION

Hereinafter, exemplary embodiments disclosed the present disclosure will be described in detail with reference to the accompanying drawings, and the same or similar components are denoted by the same reference numerals regardless of reference numerals, and repeated description thereof will be omitted. In the following description, the terms “module” and “unit” for referring to elements are assigned and used exchangeably in consideration of convenience of explanation, and thus, the terms per se do not necessarily have different meanings or functions. Further, in describing the exemplary embodiment disclosed in the present specification, when it is determined that a detailed description of a related publicly known technology may obscure the gist of the exemplary embodiment disclosed in the present specification, the detailed description thereof will be omitted. Further, the accompanying drawings are provided for more understanding of the embodiment disclosed in the present specification, but the technical spirit disclosed in the present disclosure is not limited by the accompanying drawings. It should be understood that all changes, equivalents, and alternatives included in the spirit and the technical scope of the present disclosure are included.

Although the terms first, second, third, and the like, may be used herein to describe various elements, components, regions, layers, and/or sections, these elements, components, regions, layers, and/or sections should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, it should be understood that, when it is described that an element is directly coupled or directly connected to another element, no element is present between the element and the other element.

The text recognition method and apparatus according to an embodiment of the present disclosure relates to recognizing a text displayed on media, and more particularly, to recognizing a text embossed or printed on media based on captured images of the media. Here, various cards such as a credit card, a check card, an identification card, a signboard with a text, goods with a text, etc. may be included.

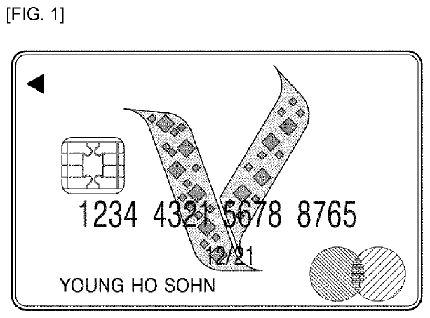

FIG. 1 is an exemplary diagram of an embossed text type card in which a text recognition method according to an embodiment of the present disclosure may be used.

Referring to FIG. 1, a credit card image of an embossed text display method and of Visa series, which is commonly used a lot, is shown. In the shown credit card, the card number is engraved in an embossed type, and the alphabet V shaped figure is overlaid with the card number. Since the conventional OCR engine has been designed for the recognition of the printed text, there is a drawback in that the recognition rate is reduced in the text recognition of the embossed type credit card. Accordingly, there is a need for an algorithm for recognition of the embossed text object and an algorithm capable of distinguishing the embossed text from the printed text.

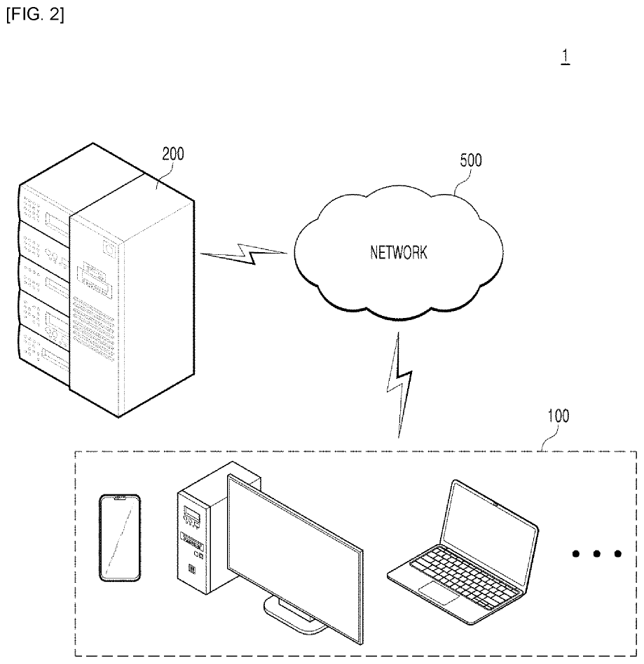

FIG. 2 is an exemplary diagram of a network environment of a text recognition apparatus according to an embodiment of the present disclosure.

Referring to FIG. 2, a text recognition apparatus 100 and a server 200 according to an embodiment of the present disclosure are communicatively connected through a network 500.

In the range of the text recognition apparatus according to an embodiment of the present disclosure, various types of terminals 100, such as a mobile terminal, a laptop computer, and a personal computer (PC) may be included.

The server 200 serves to provide various services related to an artificial intelligence model to the terminal 100 with regard an artificial intelligence model which will be described in an exemplary embodiment of the present disclosure. Detailed description of the artificial intelligence model will be provided below.

The terminal 100 may be implemented as a stationary terminal and a mobile terminal, such as a mobile phone, a projector, a mobile phone, a smartphone, a laptop computer, a terminal for digital broadcast, a personal digital assistant (PDA), a portable multimedia player (PMP), a navigation system, a slate PC, a tablet PC, an ultrabook, a wearable device (for example, a smartwatch, a smart glass, and a head mounted display (HMD)), a set-top box (operation STB), a digital multimedia broadcast (DMB) receiver, a radio, a laundry machine, a refrigerator, a desktop computer, a digital signage.

The network 400 may be any suitable communication network including a wired and wireless network, for example, a local area network (LAN), a wide area network (WAN), an internet, an intranet, an extranet, and a mobile network, for example, cellular, 3G, LTE, 5G, WiFi networks, an ad hoc network, and a combination thereof.

The network 400 may include a connection of network elements such as a hub, a bridge, a router, a switch, and a gateway. The network 400 may include one or more connected networks, for example, a multi-network environment, including a public network such as an internet and a private network such as a safe corporate private network. The access to the network 400 may be provided via one or more wired or wireless access networks.

The terminal 100 may transmit and receive data with a server 200 which is a learning device, through a 5G network. Specifically, the human body recognition usable terminal 100, 300 may perform data communication with the learning device 200 using at least one service of enhanced mobile broadband (eMBB), ultra-reliable and low latency communications (URLLC), and massive machine-type communications (mMTC) through the 5G network.

eMBB (enhanced mobile broadband) is a mobile broadband service, and multimedia contents, wireless data access, etc. are provided through eMBB (enhanced mobile broadband). Further, more improved mobile services such as a hotspot and a wideband coverage for receiving mobile traffic that are tremendously increasing may be provided through eMBB. Large traffic may be received to an area with little mobility and high density of users through a hotspot. A wide and stable wireless environment and user mobility may be secured by a wideband coverage.

A URLLC (ultra-reliable and low latency communications) service defines very severer requirements than existing LTE in terms of reliability in data transmission/reception and transmission delay, and 5G services for production process automation at industrial sites, telemedicine, telesurgery, transportation, safety, etc. are representative.

mMTC (massive machine-type communications) is a service that is not sensitive to transmission delay requiring a relatively small amount of data transmission. A large number of terminals more than common mobile phones such as sensors may simultaneously connect with a wireless access network by mMTC. In this case, the price of the communication module of a terminal should be low and a technology improved to increase power efficiency and save power is required to enable operation for several years without replacing or recharging a battery.

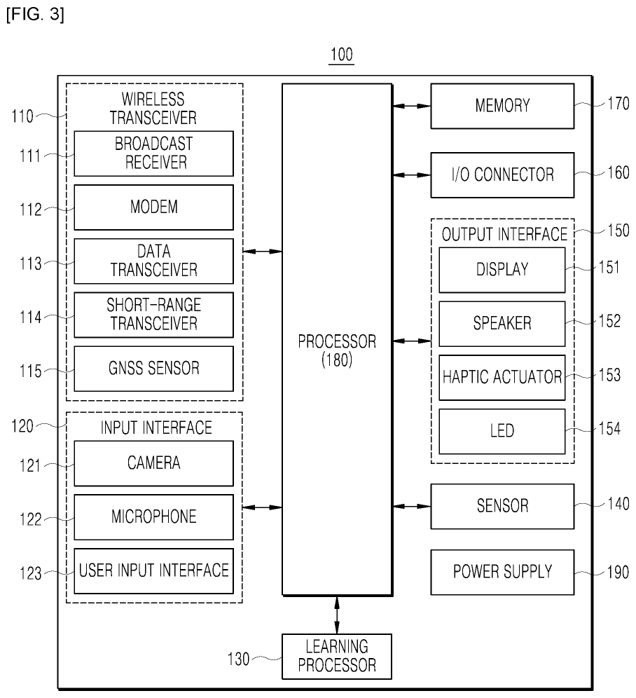

FIG. 3 is a block diagram of a terminal corresponding to a text recognition apparatus according to an embodiment of the present disclosure.

Referring to FIG. 3, the terminal 100 includes a wireless transceiver 110, an input interface 120, a learning processor 130, a sensing unit 140, an output interface 150, an I/O connector 160, a memory 170, a processor 180, and a power supply 190.

A learning model (a trained model) may be loaded in the terminal 100.

In the meantime, the learning model may be implemented by hardware, software, or a combination of hardware and software. When a part or all of the learning model is implemented by software, one or more commands which configure the learning model may be stored in the memory 170.

The wireless transceiver 110 may include at least one of a broadcasting receiving module 111, a mobile communication module 112, a wireless internet module 113, a short-range communication module 114, and a position information module 115.

The broadcasting receiving module 111 receives a broadcasting signal and/or broadcasting related information from an external broadcasting management server through a broadcasting channel.

The mobile communication module 112 may transmit/receive a wireless signal to/from at least one of a base station, an external terminal, and a server on a mobile communication network established according to the technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

The wireless internet module 113 refers to a module for wireless internet access and may be built in or external to the terminal 100. The wireless internet module 113 may be configured to transmit/receive a wireless signal in a communication network according to wireless internet technologies.

The wireless internet technologies may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A).

The short-range communication module 114 may support Short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies.

The position information module 115 is a module for obtaining the location (or the current location) of a mobile terminal, and its representative examples include a global locationing system (GPS) module or a Wi-Fi module. For example, the mobile terminal may obtain its location by using a signal transmitted from a GPS satellite through the GPS module.

The input interface 120 may include a camera 121 which inputs an image signal, a microphone 122 which receives an audio signal, and a user input interface 123 which receives information from the user.

Voice data or image data collected by the input interface 120 is analyzed to be processed as a control command of the user.

The input interface 120 may obtain training data for training a model and input data used to obtain an output using the trained model.

The input interface 120 may obtain input data which is not processed, and, in this case, the processor 180 or the learning processor 130 pre-processes the obtained data to generate training data to be input to the model learning or pre-processed input data.

In this case, the pre-processing on the input data may refer to extracting of an input feature from the input data.

The input interface 120 is provided to input image information (or signal), audio information (or signal), data, or information input from the user and in order to input the image information, the terminal 100 may include one or a plurality of cameras 121.

The camera 121 processes an image frame such as a still image or a moving image obtained by an image sensor in a video call mode or a photographing mode. The processed image frame may be displayed on the display 151 or stored in the memory 170.

The microphone 122 processes an external sound signal as electrical voice data. The processed voice data may be utilized in various forms in accordance with a function which is being performed by the terminal 100 (or an application program which is being executed). In the meantime, in the microphone 122, various noise removal algorithms which remove a noise generated during the process of receiving the external sound signal may be implemented.

The user input interface 123 receives information from the user and when the information is input through the user input interface 123, the processor 180 may control the operation of the terminal 100 so as to correspond to the input information.

The user input interface 123 may include a mechanical input interface (or a mechanical key, for example, a button located on a front, rear, or side surface of the terminal 100, a dome switch, a jog wheel, or a jog switch) and a touch type input interface. For example, the touch type input interface may be formed by a virtual key, a soft key, or a visual key which is disposed on the touch screen through a software process or a touch key which is disposed on a portion other than the touch screen.

The learning processor 130 learns the model configured by an artificial neural network using the training data.

Specifically, the learning processor 130 repeatedly trains the artificial neural network using the aforementioned various learning techniques to determine optimized model parameters of the artificial neural network.

In this specification, the artificial neural network which is trained using training data to determine parameters may be referred to as a learning model or a trained model.

In this case, the learning model may be used to deduce a result for the new input data, rather than the training data.

The learning processor 130 may be configured to receive, classify, store, and output information to be used for data mining, data analysis, intelligent decision making, and machine learning algorithm and techniques.

The learning processor 130 may include one or more memory units configured to store data which is received, detected, sensed, generated, previously defined, or output by another component, device, the terminal, or a device which communicates with the terminal.

The learning processor 130 may include a memory which is combined with or implemented in the terminal. In some exemplary embodiments, the learning processor 130 may be implemented using the memory 170.

Selectively or additionally, the learning processor 130 may be implemented using a memory related to the terminal, such as an external memory which is directly coupled to the terminal or a memory maintained in the server which communicates with the terminal.

According to another exemplary embodiment, the learning processor 130 may be implemented using a memory maintained in a cloud computing environment or other remote memory locations accessible by the terminal via a communication method such as a network.

The learning processor 130 may be configured to store data in one or more databases to identify, index, categorize, manipulate, store, search, and output data in order to be used for supervised or non-supervised learning, data mining, predictive analysis, or used in the other machine. Here, the database may be implemented using the memory 170, a memory 230 of the learning device 200, a memory maintained in a cloud computing environment or other remote memory locations accessible by the terminal via a communication method such as a network.

Information stored in the learning processor 130 may be used by the processor 180 or one or more controllers of the terminal using an arbitrary one of different types of data analysis algorithms and machine learning algorithms.

As an example of such an algorithm, a k-nearest neighbor system, fuzzy logic (for example, possibility theory), a neural network, a Boltzmann machine, vector quantization, a pulse neural network, a support vector machine, a maximum margin classifier, hill climbing, an inductive logic system, a Bayesian network, (for example, a finite state machine, a Mealy machine, a Moore finite state machine), a classifier tree (for example, a perceptron tree, a support vector tree, a Markov Tree, a decision tree forest, an arbitrary forest), a reading model and system, artificial fusion, sensor fusion, image fusion, reinforcement learning, augmented reality, pattern recognition, automated planning, and the like, may be provided.

The processor 180 may determine or predict at least one executable operation of the terminal based on information which is determined or generated using the data analysis and the machine learning algorithm. To this end, the processor 180 may request, search, receive, or utilize the data of the learning processor 130 and control the terminal to execute a predicted operation or a desired operation among the at least one executable operation.

The processor 180 may perform various functions which implement intelligent emulation (that is, a knowledge based system, an inference system, and a knowledge acquisition system). This may be applied to various types of systems (for example, a fuzzy logic system) including an adaptive system, a machine learning system, and an artificial neural network.

The processor 180 may include sub modules which enable operations involving voice and natural language voice processing, such as an I/O processing module, an environmental condition module, a speech to text (operation STT) processing module, a natural language processing module, a workflow processing module, and a service processing module.

The sub modules may have an access to one or more systems or data and a model, or a subset or a super set thoseof in the terminal. Further, each of the sub modules may provide various functions including a glossarial index, user data, a workflow model, a service model, and an automatic speech recognition (ASR) system.

According to another exemplary embodiment, another aspect of the processor 180 or the terminal may be implemented by the above-described sub module, a system, data, and a model.

In some exemplary embodiments, based on the data of the learning processor 130, the processor 180 may be configured to detect and sense requirements based on contextual conditions expressed by user input or natural language input or user's intention.

The processor 180 may actively derive and obtain information required to completely determine the requirement based on the contextual conditions or the user's intention. For example, the processor 180 may actively derive information required to determine the requirements, by analyzing past data including historical input and output, pattern matching, unambiguous words, and input intention.

The processor 180 may determine a task flow to execute a function responsive to the requirements based on the contextual condition or the user's intention.

The processor 180 may be configured to collect, sense, extract, detect and/or receive a signal or data which is used for data analysis and a machine learning task through one or more sensing components in the terminal, to collect information for processing and storing in the learning processor 130.

The information collection may include sensing information by a sensor, extracting of information stored in the memory 170, or receiving information from other equipment, an entity, or an external storage device through a transceiver.

The processor 180 collects usage history information from the terminal and stores the information in the memory 170.

The processor 180 may determine best matching to execute a specific function using stored usage history information and predictive modeling.

The processor 180 may receive or sense surrounding environment information or other information through the sensor 140.

The processor 180 may receive a broadcasting signal and/or broadcasting related information, a wireless signal, or wireless data through the wireless transceiver 110.

The processor 180 may receive image information (or a corresponding signal), audio information (or a corresponding signal), data, or user input information from the input interface 120.

The processor 180 may collect the information in real time, process or classify the information (for example, a knowledge graph, a command policy, a personalized database, or a conversation engine) and store the processed information in the memory 170 or the learning processor 130.

When the operation of the terminal is determined based on data analysis and a machine learning algorithm and technology, the processor 180 may control the components of the terminal to execute the determined operation. Further, the processor 180 may control the equipment in accordance with the control command to perform the determined operation.

When a specific operation is performed, the processor 180 analyzes history information indicating execution of the specific operation through the data analysis and the machine learning algorithm and technology and updates the information which is previously learned based on the analyzed information.

Accordingly, the processor 180 may improve precision of a future performance of the data analysis and the machine learning algorithm and technology based on the updated information, together with the learning processor 130.

The sensor 140 may include one or more sensors which sense at least one of information in the mobile terminal, surrounding environment information around the mobile terminal, and user information.

For example, the sensor 140 may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger may sensor, an ultrasonic sensor, an optical sensor (for example, a camera 121), a microphone 122, a battery gauge, an environment sensor (for example, a barometer, a hygrometer, a thermometer, a radiation sensor, a thermal sensor, or a gas sensor), and a chemical sensor (for example, an electronic nose, a healthcare sensor, or a biometric sensor). On the other hand, the terminal 100 disclosed in the present disclosure may combine various kinds of information sensed by at least two of the above-mentioned sensors and may use the combined information.

The output interface 150 is intended to generate an output related to a visual, aural, or tactile stimulus and may include at least one of a display 151, speaker 152, haptic actuator 153, and LED 154.

The display 151 displays (outputs) information processed in the terminal 100. For example, the display 151 may display execution screen information of an application program driven in the terminal 100 and user interface (UI) and graphic user interface (GUI) information in accordance with the execution screen information.

The display 151 forms a mutual layered structure with a touch sensor or is formed integrally to be implemented as a touch screen. The touch screen may simultaneously serve as a user input interface 123 which provides an input interface between the terminal 100 and the user and provide an output interface between the terminal 100 and the user.

The speaker 152 may output audio data received from the wireless transceiver 110 or stored in the memory 170 in a call signal reception mode, a phone-call mode, a recording mode, a voice recognition mode, or a broadcasting reception mode.

The speaker 152 may include at least one of a receiver, a speaker, and a buzzer.

The haptic module 153 may generate various tactile effects that the user may feel. A representative example of the tactile effect generated by the haptic module 153 may be vibration.

The LED 154 outputs a signal for notifying occurrence of an event using light of a light source of the terminal 100. Examples of the event generated in the terminal 100 may be message reception, call signal reception, missed call, alarm, schedule notification, email reception, and information reception through an application.

The I/O connector 160 serves as a passage with various types of external devices which are connected to the terminal 100. The I/O connector 160 may include at least one of a wired/wireless headset port, an external charger port, a wired/wireless data port, a memory card port, a port which connects a device equipped with an identification module, an audio input/output (I/O) port, a video input/output (I/O) port, and an earphone port. The terminal 100 may perform appropriate control related to the connected external device in accordance with the connection of the external device to the I/O connector 160.

In the meantime, the identification module is a chip in which various information for authenticating a usage right of the terminal 100 is stored and includes a user identification module (UIM), a subscriber identify module (operation SIM), and a universal subscriber identity module (USIM). The device with an identification module (hereinafter, “identification device”) may be manufactured as a smart card. Accordingly, the identification device may be connected to the terminal 100 through the I/O connector 160.

The memory 170 stores data which supports various functions of the terminal 100.

The memory 170 may store various application programs (or applications) driven in the terminal 100, data for the operation of the terminal 100, commands, and data (for example, at least one algorithm information for machine learning) for the operation of the learning processor 130.

The memory 170 may store the model which is learned in the learning processor 130 or the learning device 200.

If necessary, the memory 170 may store the trained model by dividing the model into a plurality of versions depending on a training timing or a training progress.

In this case, the memory 170 may store input data obtained from the input interface 120, learning data (or training data) used for model learning, a learning history of the model, and so forth.

In this case, the input data stored in the memory 170 may be not only data which is processed to be suitable for the model learning but also input data itself which is not processed.

Further to the operation related to the application program, the processor 180 may generally control an overall operation of the terminal 100. The processor 180 may process a signal, data, or information which is input or output through the above-described components or drives the application programs stored in the memory 170 to provide or process appropriate information or functions to the user.

Further, in order to drive the application program stored in the memory 170, the processor 180 may control at least some of components described with reference to FIG. 3. Moreover, the processor 180 may combine and operate at least two of components included in the terminal 100 to drive the application program.

In the meantime, as described above, the processor 180 may control an operation related to the application program and an overall operation of the terminal 100. For example, when the state of the terminal satisfies a predetermined condition, the processor 180 may execute or release a locking state which restricts an input of a control command of a user for the applications.

The power supply 190 is applied with external power or internal power to supply the power to the components included in the terminal 100 under the control of the processor 180. The power supply 190 includes a battery and the battery may be an embedded battery or a replaceable battery.

The terminal 100 may perform a function of a voice agent. The voice agent may be a program which recognizes a voice of the user and outputs a response appropriate for the recognized voice of the user as a voice.

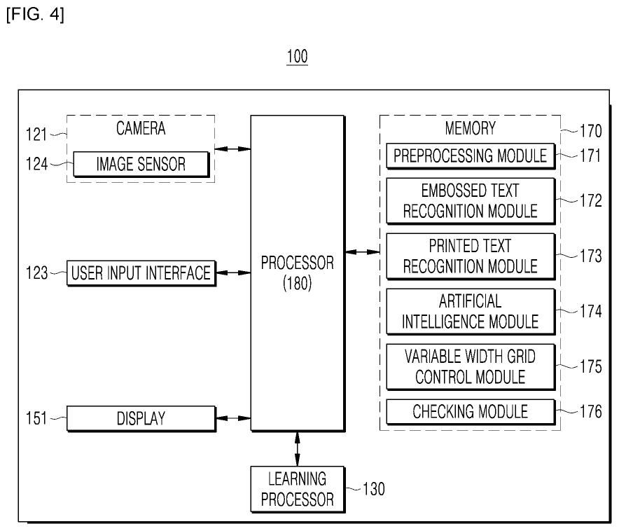

FIG. 4 is a block diagram of a memory according to an exemplary embodiment of the present disclosure.

Referring to FIG. 4, the terminal 100 is briefly illustrated together with components of the memory 170. In the memory, various computer program modules may be loaded. The computer program mounted in the memory 170 includes a preprocessing module, an embossed text recognition module 172, a printed text recognition module 173, an artificial intelligence model. 174, a variable width grid control module 175, and a checking module 176 as an application program, in addition to the system program that manages an operating system and hardware. Here, some of the application programs may be implemented in a hardware form such as an integrated circuit (IC).

The processor 180 is set to control respective modules 171 to 176 mounted in the memory 170, and a corresponding function is performed through the respective modules according to this setting.

The respective modules may be set to include a command set for each function constituting a text recognition method according to an embodiment of the present disclosure. Various logic circuits included in the processor 180 may read an instruction set of various modules loaded in the memory 170, and the functions of each module may be performed by the terminal 100 in the execution process.

The preprocessing module 171 serves to perform preprocessing for the input image. Here, the range of preprocessing may include image binarization, noise removal, card area detection, geometric transformation, card number area detection, and brightness histogram analysis.

The embossed text recognition module 172 serves to recognize an embossed text displayed on the card surface.

The print text recognition module 173 recognizes text printed on the card surface.

The artificial intelligence model 174 serves to find a pattern with respect to the input image based on the experience accumulated through learning, or to recognize the text through comparative analysis with the learned result.

Here, the terminal 100 may include the artificial intelligence model 174. The artificial intelligence model 174 may be trained to learn information on the vertical location and the horizontal location of the card number area by card company, for example, through machine learning. As an exemplary embodiment, the artificial intelligence model 174 is subjected to a learning process and an evaluation process in the server 200 which is a learning device 200 to be completed and then stored in the memory 170 of the terminal 100.

In addition, the stored artificial intelligence model 174 may recognize various patterns resulting from the feature of the image collected through the terminal 100 through a second learning process using the user log data collected by the terminal 100.

The variable width grid control module 175 serves to detect a digit area constituting a card number in the horizontal segmentation of the card number.

The checking module 176 serves to perform a reliability check on the recognized card number and the expiration date. The checking module 176 may perform multiple checking, such as a Luhn check, an issuer identification number (T N) check, a bank identification number (BIN) check, a check based on multiple image frames sometimes referred to as a multi-frame check, and determining a prediction confidence of a convolutional neural network (CNN) based on a mean of confidence level values resulting from CNN recognition processing, sometimes referred to as a CNN Mean Confidence check, with respect to the recognized text. In all 16 digits constituting the card number of the Visa series card, the first to fifth digits represent a bank identification number (BIN). Specifically, the Visa card has a first digit of 4, the Master card has a first digit of 51, and the Diners card has a first to fourth digits of 3616.

The seventh to fifteenth digits follow any rule of the issuer. In addition, the last 16 digits correspond to a verification value used for Luhn Check.

Accordingly, recognition errors of the first six digits and the last digit may be prevented in advance through BIN information and Luhn check for each card company according to an embodiment of the present disclosure.

Until now, although it has been described that various application modules stored in the memory 170 under the control of the processor 180 perform each function, some or all of the various application modules included in the memory 170 may be stored in the server 200 side, and the terminal 100 may transmit and receive data by using each module of the wireless transceiver 110 to process the application module in the server 200.

The server 200 may detect a card number area and a digit area according to learning and provide to the terminal 100 learning data necessary for training the artificial intelligence model capable of recognizing a text and computer programs, for example, API, data workflows, etc., related to various artificial intelligence algorithms.

Further, the server 200 may also detect the card number area and the digit area, collect learning data necessary for learning for text recognition in the form of user log data through the terminal 100, and provide the artificial intelligence model directly having learned by using the collected learning data to the terminal 100. Accordingly, the server 200 may be referred to as the learning device 200.

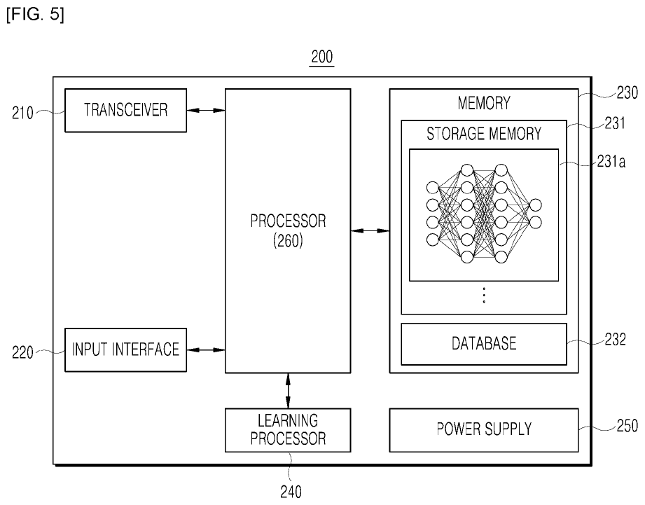

FIG. 5 is a block diagram of a learning device according to an embodiment of the present disclosure.

The learning device 200 is a device or a server which is separately configured at the outside of the terminal 100 and may perform the same function as the learning processor 130 of the terminal 100.

That is, the learning device 200 may be configured to receive, classify, store, and output information to be used for data mining, data analysis, intelligent decision making, and machine learning algorithms. Here, the machine learning algorithm may include a deep learning algorithm.

The learning device 200 may communicate with at least one terminal 100 and derive a result by analyzing or learning the data on behalf of the terminal 100. Here, the meaning of “on behalf of the other device” may be distribution of a computing power by means of distributed processing.

The learning device 200 of the artificial neural network is various devices for learning an artificial neural network and normally, refers to a server, and also referred to as a learning device or a learning server.

Specifically, the learning device 200 may be implemented not only by a single server, but also by a plurality of server sets, a cloud server, or a combination thereof.

That is, the learning device 200 is configured as a plurality of learning devices to configure a learning device set (or a cloud server) and at least one learning device 200 included in the learning device set may derive a result by analyzing or learning the data through the distributed processing.

The learning device 200 may transmit a model trained by the machine learning or the deep learning to the terminal 100 periodically or upon the request.

Referring to FIG. 5, the learning device 200 is a device or a server which is separately configured at the outside of the terminal 100 and may perform the same function as the learning processor 130 of the terminal 100.

That is, the learning device 200 may be configured to receive, classify, store, and output information to be used for data mining, data analysis, intelligent decision making, and machine learning algorithms. Here, the machine learning algorithm may include a deep learning algorithm.

The learning device 200 may communicate with at least one terminal 100 and derive a result by analyzing or learning the data on behalf of the terminal 100. Here, the meaning of “on behalf of the other device” may be distribution of a computing power by means of distributed processing.

The learning device 200 of the artificial neural network is various devices for learning an artificial neural network and normally, refers to a server, and also referred to as a learning device or a learning server.

Specifically, the learning device 200 may be implemented not only by a single server, but also by a plurality of server sets, a cloud server, or a combination thereof.

That is, the learning device 200 is configured as a plurality of learning devices to configure a learning device set (or a cloud server) and at least one learning device 200 included in the learning device set may derive a result by analyzing or learning the data through the distributed processing.

The learning device 200 may transmit a model trained by the machine learning or the deep learning to the terminal 100 periodically or upon the request.

Referring to FIG. 5, the learning device 200 may include a transceiver 210, an input interface 220, a memory 230, a learning processor 240, a power supply 250, a processor 260, and so forth.

The transceiver 210 may correspond to a configuration including the wireless transceiver 110 and the I/O connector 160 of FIG. 3. That is, the transceiver may transmit and receive data with the other device through wired/wireless communication or an interface.

The input interface 220 is a configuration corresponding to the input interface 120 of FIG. 3 and may receive the data through the transceiver 210 to obtain data.

The input interface 220 may obtain input data for acquiring an output using training data for model learning and a trained model.

The input interface 220 may obtain input data which is not processed, and, in this case, the processor 260 may pre-process the obtained data to generate training data to be input to the model learning or pre-processed input data.

In this case, the pre-processing on the input data performed by the input interface 220 may refer to extracting of an input feature from the input data.

The memory 230 is a configuration corresponding to the memory 170 of FIG. 3.

The memory 230 may include a storage memory 231, a database 232, and so forth.

The storage memory 231 stores a model (or an artificial neural network 231a) which is learning or trained through the learning processor 240 and when the model is updated through the learning, stores the updated model.

If necessary, the storage memory 231 stores the trained model by dividing the model into a plurality of versions depending on a training timing or a training progress.

The artificial neural network 231a illustrated in FIG. 5 is one example of artificial neural networks including a plurality of hidden layers but the artificial neural network of the present disclosure is not limited thereto.

The artificial neural network 231a may be implemented by hardware, software, or a combination of hardware and software. When a part or all of the artificial neural network 231a is implemented by the software, one or more commands which configure the artificial neural network 231a may be stored in the memory 230.

The database 232 stores input data obtained from the input interface 220, learning data (or training data) used to learn a model, a learning history of the model, and so forth.

The input data stored in the database 232 may be not only data which is processed to be suitable for the model learning but also input data itself which is not processed.

The learning processor 240 is a configuration corresponding to the learning processor 130 of FIG. 3.

The learning processor 240 may train (or learn) the artificial neural network 231a using training data or a training set.

The learning processor 240 may immediately obtain data which is obtained by pre-processing input data obtained by the processor 260 through the input interface 220 to learn the artificial neural network 231a or obtain the pre-processed input data stored in the database 232 to learn the artificial neural network 231a.

Specifically, the learning processor 240 repeatedly may train the artificial neural network 231a using various learning techniques described above to determine optimized model parameters of the artificial neural network 231a.

In this specification, the artificial neural network which is trained using training data to determine parameters may be referred to as a learning model or a trained model.

In this case, the learning model may be loaded in the learning device 200 to deduce the result value or may be transmitted to the other device such as the terminal 100 through the transceiver 210 to be loaded.

Further, when the learning model is updated, the updated learning model may be transmitted to the other device such as the terminal 100 via the transceiver 210 to be loaded.

The power supply 250 is a configuration corresponding to the power supply 190 of FIG. 3. A redundant description for corresponding configurations will be omitted.

Further, the learning device 200 may evaluate the artificial intelligence model and update the artificial intelligence model for better performance even after the evaluation and provide the updated artificial intelligence model to the terminal 100. Here, the terminal 100 may perform a series of steps performed by the learning device 200 solely in a local area or together with the learning device 200 through the communication with the learning device 200. For example, the terminal 100 may allow the artificial intelligence model to learn a personal pattern of the user through the learning by the user's personal data to update the artificial intelligence model which is downloaded from the learning device 200.

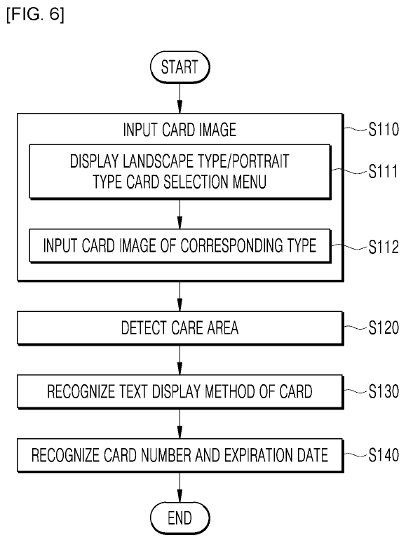

FIG. 6 is a flowchart of a text recognition process according to an example embodiment of the present disclosure.

Referring to FIG. 6, the method for text recognition S100 according to an embodiment of the present disclosure may include operations S110 to S140. In addition, each operation may be performed by the text recognition apparatus 100, that is, the processor 180, according to an embodiment of the present disclosure. Each operation will be described below.

The processor 180 may receive a card image (operation S110). The card image may be one of an image immediately captured through a camera 121 included in the terminal 100, an image captured and stored in the past, and an image received through the outside, for example, a communication means such as an SNS, an e-mail, or a messenger.

In inputting the card image, the processor 180 may display to the user information on various guidelines on composition, lighting, focus, and anti-shake of the camera.

A typical credit card includes a morphological feature, that is, a card number having an embossed text of a horizontal design. However, in recent years, a lot of cards of a vertical design are issued, such that a recognition algorithm adaptive to the card of the vertical design should be applied. Before the terminal 100 determines whether it is the vertical design, if information on the vertical design can be obtained from the user in advance, the vertical design determination operation of the terminal 100 may be skipped.

According to an embodiment of the present disclosure, the processor 180 may control a user interface (UI) so that the horizontally designed and vertically designed cards may be distinguished from each other in the inputting the card image.

In order to implement this, the processor 180 may display a menu capable of selecting a horizontal type/vertical type card by using the card image (operation S111).

Next, the processor 180 may receive a card image suitable for the card design type selected by the user (operation S112).

The processor 180 may receive a plurality of images. Further, the processor 180 may set an operation of the camera so as to process a capturing operation by focusing on the card surface despite one-time shutter operation of the user. Accordingly, the processor 180 may receive a plurality of card images having a modified focus point as the original image.

The processor 180 may select a target image for a text recognition task from among a plurality of input card images. The selection criterion is whether the focus is accurate, and the processor 180 may select a card image having a good focus through a focus determination process.

The processor 180 may obtain the standard deviation of the contour in the card image subjected to the sobel edge processing. This standard deviation may be defined as a focus score. The image with a large focus score, that is, a large standard deviation, has a sharp outline due to a well-focused focus. The image with a small focus score, that is, a small standard deviation, has a blurred outline due to a poorly-focused focus. Accordingly, among the obtained card images, an image having the standard deviation of a threshold or more or a card image having the largest standard deviation may be selected as the target image.

The processor 100 may detect the card area from the selected card image (operation S120). This process corresponds to a selectable process for adding reliability a text recognition rate rather than an essential process for text recognition. The advantage after the determination of the card area is that, when the credit card corresponds to the ISO standard, the location of the card number and the location of the expiration date in the card area determined according to the feature of the card issuer may be predicted in advance.

FIG. 7 is an exemplary diagram of a card area detecting process according to an embodiment of the present disclosure. The card area detection may be configured to include internally edge detection, intersection calculation between edges, and perspective transform.

Referring to FIG. 7, the first image shows a raw image, the second image shows a card edge recognition process, the third image shows an intersection calculation by four edges, and the fourth image shows perspective transform.

The raw image refers to the image taken by the user. The raw image may include unnecessary areas other than the card area. Sometimes, the card image whose card area is covered by a finger, etc. may also be used as the raw image.

The processor 180 may use the raw image as it is for edge recognition, but perform a preprocessing process for removing a portion unnecessary for text recognition, for example, color information to change it into the black and white image and to remove noise.

Next, the processor 180 may recognize four edges of the card by using an edge recognition algorithm with respect to the preprocessed card image. Canny Edge Detection and Hough Line Transform algorithms may be used as an edge recognition algorithm.

In the edge detection according to an embodiment of the present disclosure, the processor 180 may detect the edge of the card by using the Canny Edge Detection algorithm. The application process of the Canny Edge Detection algorithm may be again configured to include removing the image noise using Gaussian filter, obtaining gradient by applying the sobel kernel to the image with noise removed, performing Non-maximum suppression, and Edge tracking by hysteresis thresholding. A short straight line extends through the Hough Line transform, and one of these straight lines may be detected as an edge.

In the edge detection according to an embodiment of the present disclosure, the processor 180 may efficiently perform the card edge detection by comparing angles between horizontal edges, comparing angles between vertical edges, and reflecting a card ratio. For example, four edge regions of the card image will be named first to fourth areas clockwise from the top horizontal edge. It is assumed that the first to third edges are recognized in the first area, and three candidate edges are recognized in each region in the same manner, such that a total of 12 edge candidates have been recognized. In this case, the processor 180 may detect an optimal combination of edges among the combination of a total of 3⁴ edges by comparing the angles between the edges and reflecting the card ratio.

The processor 180 may compare the angles between the edges facing each other based on the composition information, and detect pairs of edges that may appear in the corresponding composition as appropriate edges. Further, the processor 180 may detect an edge that meets the standard information, which is a landscape of 8.56 cm, a portrait of 5.398 cm, and a ratio of portrait to landscape of 1:1.585, as an appropriate edge.

As an embodiment of the present disclosure, the processor 180 may calculate four intersections generated by intersecting four edges detected in the entire process. The card image formed by the four intersections may be a distorted image deviating from the rectangular shape according to the camera composition.

As an embodiment of the present disclosure, the processor 180 may correct the trapezoidal distortion of the card area due to the perspective by using a perspective transform. Accordingly, even when the location of the camera is deviated from the center of the card or the image captured in a state not parallel to the card surface is input, the input image may be used as the target image for text recognition by the perspective transform.

Next, the processor 180 may determine a text display method of the card (operation S130). This process may be performed later than some processes constituting operation S140 in the relationship with the operation S140 corresponding to the next operation. That is, this is because some of the processes for recognizing the card number and the expiration date may be performed earlier than the operation S130. That is, during the process of recognizing the card number and the expiration date (operation S140), the text display method of the card may be determined, and according to the result, the processor 180 may recognize the card number and the expiration date (operation S140).

The text recognition according to an embodiment of the present disclosure may be configured to include the card number recognition and the expiration date recognition. Further, the recognition of the card number may be configured to include the area detection of the card number and the number recognition in the detected area. Here, the area detection of the card number may be configured to include detection of the vertical area and detection of the horizontal area.

Hereinafter, a text recognition process of the card number and the expiration date on the surface of the credit card will be described in detail with reference to a drawing showing a specific process.

The card number area should be detected before the card number recognition. The detection of the card number area is summarized by the detection of the vertical location and the horizontal location of the card number array. In order to detect the location, it is necessary to analyze the pixel structure of the card image.

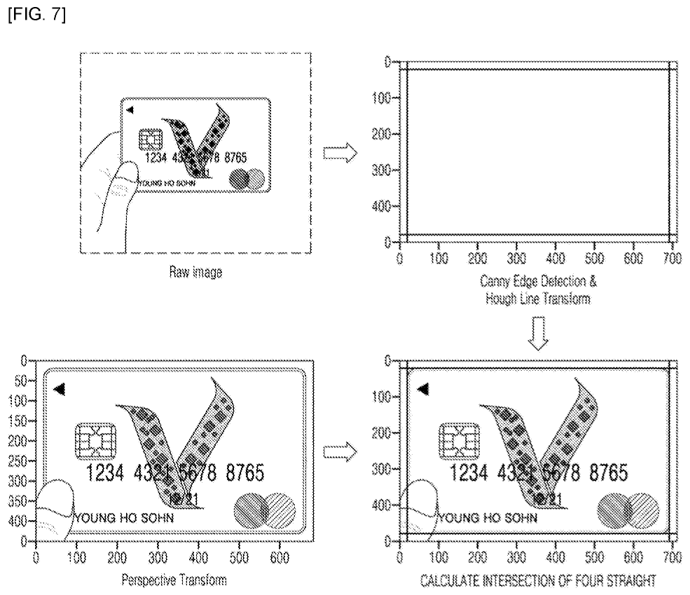

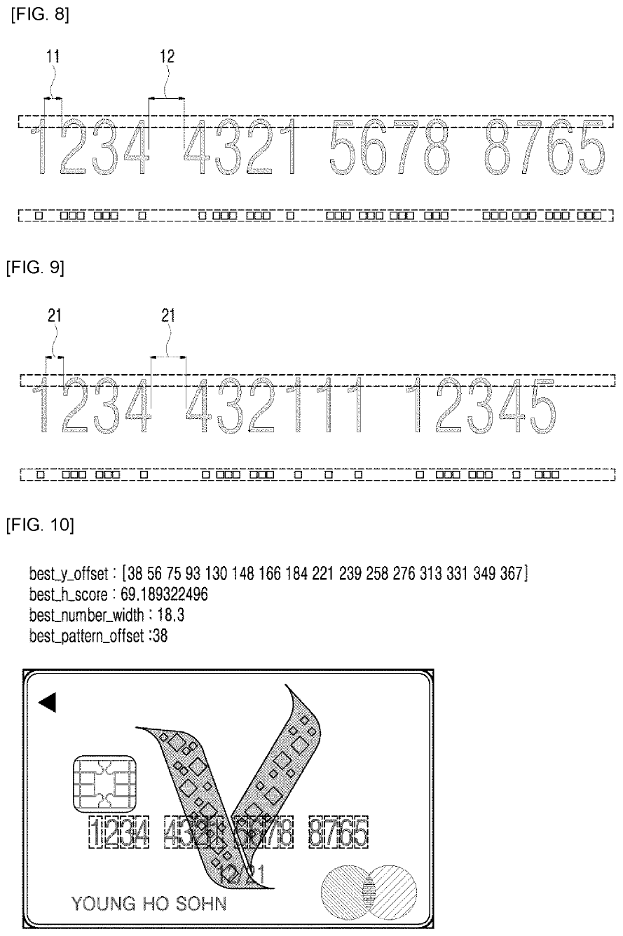

FIG. 8 is an exemplary diagram of the card number area according to an embodiment of the present disclosure.

FIG. 9 is an exemplary diagram of the card number area according to an embodiment of the present disclosure.

Referring to FIGS. 8 and 9, the card number area of a 16-digit Visa series card is shown in FIG. 8, and the card number area of a 15-digit Amex series card is shown in FIG. 9. The dotted lines in the upper card area of FIGS. 8 and 9 show a row of a single pixel array. Further, the lower figure schematically shows the pixels distributed in one row. In the Visa series card, 19 spaces constitute a card number area in the order of four consecutive digits, an area 11 between the digits, and one blank 12. The Amex card constitutes the card number area of four consecutive digits, an area 21 between the digits, and one blank 22, and in the same method, six consecutive digits, one blank, and five consecutive digits.

The card sizes for each card company may be the same as or different from each other. The card image extracted from the card size of a landscape of 8.56 cm and a portrait of 5,398 cm meeting the ISO International Standard is assumed to be composed of a landscape of 428 pixels and a portrait of 270 pixels.

In the detection of the card number area according to an embodiment of the present disclosure, needed is training for the recognition of the card number pattern for each card company that uses the card image as learning data as targeting an artificial intelligence model, for example, a multi-layer perceptron (MLP), which is a type of an artificial neural network.

The entire pixels constituting the card image may be segmented into 270 rows with a landscape of 428 pixels. The MLP receives 270 rows and learns the features of the pixels distributed in each row. The pixel pattern of the card number area is characterized by having a lot of black pixels forming the outline of the digit distributed compared to other areas. Further, the MLP recognizes the card number area for each card company based on the pixel pattern through learning. For example, the card number in the Visa series card is composed of 27 rows, the first row of 27 rows is the 153^{th} row of 270 rows, and the first column constituting the first digit corresponds to 38^{th} columns of a landscape of 428 columns. The MLP may recognize the pixel pattern of the card number area through learning with respect to not only the Visa series but also the American Express (hereinafter, AMEX) series card.

The vertical segmentation and horizontal segmentation processes of the card image using the learned MLP will be described. Through each segmentation process, the card number area may be detected and each digit area may be extracted.

First, the extracted card area image is input to the MLP. The MLP reads the pixels constituting the card image, and compares the read result with the learned pixel pattern for each card company to score each score. That is, when the read pixel is close to the pattern of the Visa series card, the Visa score is formed relatively high, and when the read pixel is close to the pattern of the Amex series card, the Amex score is formed relatively high. Accordingly, in this process, the card type may be determined whether it is Visa series or Amex series.

When the Visa score is higher than the Amex score, the corresponding card is most likely an embossed Visa card. Further, when the Amex score is higher than the Visa score, the corresponding card is most likely an embossed Amex card. Further, when both the Visa score and the Amex score are calculated to any threshold or less, the corresponding card is most likely a print card. This is because the Visa score and the Amex score are for the embossed card. Further, it is possible to finally determine whether the corresponding card is a print card by detecting the location of the magnet and the array direction of the card number.

The MLP may start reading from the middle row of card images based on the location of the card number area. The MLP may read the pixel, calculate the score for each row according to the read result, and sum the scores for the 27 rows. In the process of sequentially performing this operation by changing the rows, the location where the sum of the scores of 27 rows is maximized is the vertical location of the card number.

FIG. 10 is an exemplary diagram of a card number vertical segmentation according to an embodiment of the present disclosure.

Referring to FIG. 10, the card number area detected as a result of the vertical segmentation process is shown. Further, the score for the corresponding area, the start offset of the card number area, the card series, the number of spaces, the number of digits, and the digit pattern of the Visa series may be calculated as the result value of the vertical segmentation.

Based on the vertical location of the card number area, the MLP may perform horizontal segmentationing with respect to the 27 rows constituting the card area. The horizontal segmentation is a process of extracting each digit area by comparing the pixel distribution of the extracted card image and the card number pattern for each card company. For example, 16 digit areas may be extracted from four 4-digit arrays of Visa series card, and 15 digit areas may be extracted from four, six, and five digit arrays of Amex series card.

In the vertical segmentation according to an embodiment of the present disclosure, each digit area may be extracted quickly and accurately by using a variable width grid.

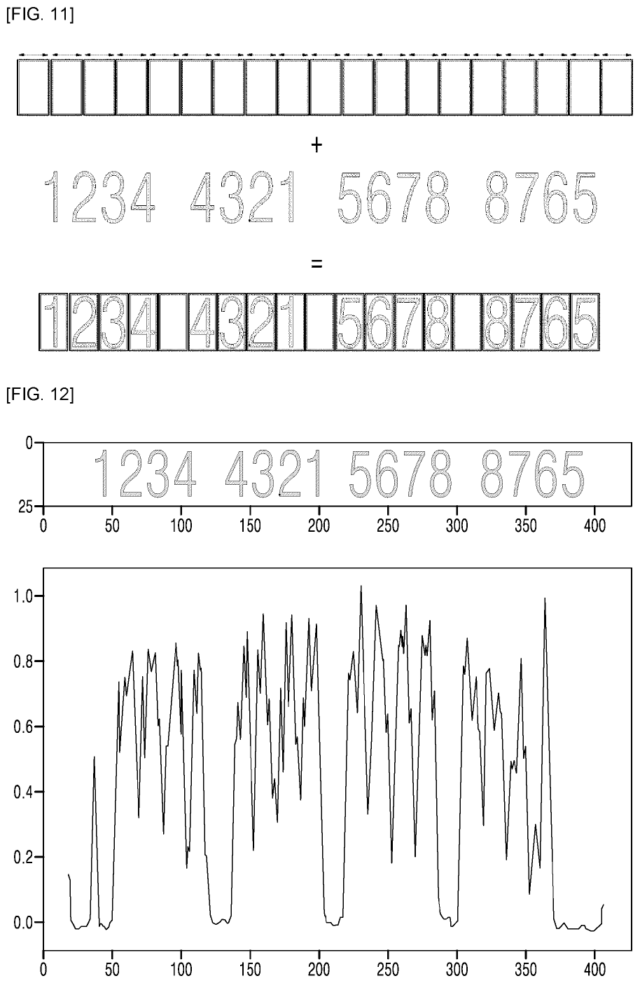

FIG. 11 is an exemplary diagram of a horizontal segmentation using a variable width grid according to an embodiment of the present disclosure.

Referring to FIG. 11, 19 spaces constituting the card number area of a Visa series card are shown. A plurality of grids having a constant vertical length and variable width may be arrayed. Such an array may be displayed on the card number area, and the width of the grid may be uniformly adjusted so that each gird fits each digit. When the variable width by the horizontal segmentation is determined at the time point having the optimal width, each digit area is determined. Here, the variable width may be determined based on the horizontal distribution pattern of the pixel for each card company.

FIG. 12 is an exemplary diagram of a score distribution according to the horizontal segmentation according to an embodiment of the present disclosure.

Referring to FIG. 12, the card number area is shown at the top, and the score distribution for the horizontal segmentation is shown at the bottom. It may be confirmed that a high score appears in each digit area according to the card number pattern.

The MLP may compare and analyze the pixel distribution constituting the row and the horizontal pattern of the pixels distributed in the card area for each card company by the learning with respect to the rows constituting the card number area, for example, 27 rows of the Visa series card, and score the score on the horizontal segmentation according to its similarity level. Finally, the MLP may decide the width and X coordinate values of the variable grid based on the score distribution obtained from the above.

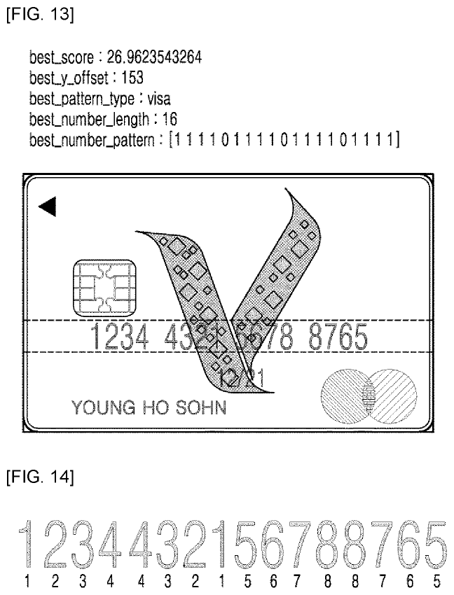

FIG. 13 is an exemplary diagram of a horizontal segmentation result according to an embodiment of the present disclosure.

Referring to FIG. 13, the digit area detected as a result of the horizontal segmentation process is shown. Further, the offset of each digit, the best score, the number of pixels of width, and the first pixel information may be calculated as a result value of the horizontal segmentation.

FIG. 14 is an exemplary diagram of each digit of the recognized text according to an embodiment of the present disclosure.

Referring to FIG. 14, the upper digit and the recognized number at the bottom are displayed.

The digit detected through the detection of the card area, the detection of the card number, and the detection of the digit area according to an embodiment of the present disclosure may be read through a text recognition process. The text recognition according to an embodiment of the present disclosure may be implemented through various algorithms. An artificial intelligence model, for example, a convolutional neural network (CNN), which is one of artificial neural networks, may read the number of the digit area by using four layers.

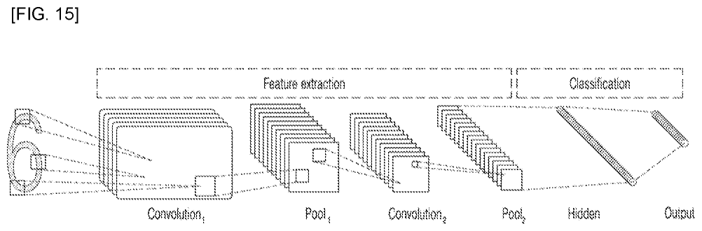

FIG. 15 is an exemplary diagram of the text recognition using an artificial intelligence model according to an embodiment of the present disclosure.

Referring to FIG. 15, a structure of a Convolutional Neural Network (CNN) for performing machine learning is shown.

The CNN may be divided into an area where a feature of the image is extracted and an area where the class is classified. The feature extraction area is configured in the form of stacking a Convolution Layer and a Pooling layer by several layers. The convolution layers are essential components which reflect an activation function after applying a filter to the input data. The Pooling Layer next to the Convolution Layer is an optional layer. At the end of the CNN, a fully connected layer for image classification is added. A flatten layer which changes the image shape into an arranged shape is located between a portion of extracting a feature of the image and an area which classifies the image.

The CNN calculates a convolution while a filter circulates the input data for extraction of the feature of the image and creates a feature map using the calculating result. A shape of the output data is changed in accordance with a size of a convolution layer filter, a stride, whether to apply padding, or a max pooling size.

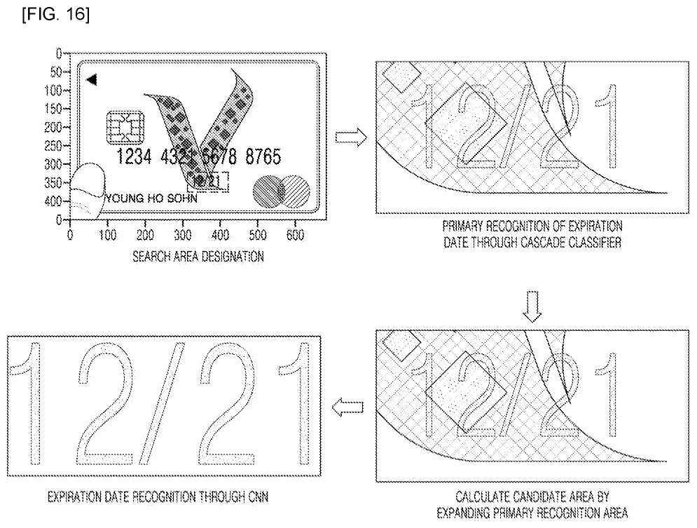

FIG. 16 is an exemplary diagram of an expiration date recognition process according to an embodiment of the present disclosure.

Referring to FIG. 16, an expiration date recognition process is shown. The first figure shows a designated search area, the second figure shows the first recognition result using the recognition algorithm, the third figure shows the candidate area expanded in the first recognition area, and the fourth figure shows the text recognition result using the artificial intelligence algorithm.

First, the processor 180 may designate an area, in which the expiration date has been displayed based on the recognized card type and the location of the card number according to the card type, as the search area.

The traditional horizontally designed card with the embossed text displays the expiration date at the bottom of the card number with a smaller font than the card number. The vertically designed card displays the card number in a plurality of rows on the rear surface of the card, and displays the expiration date under the card number. According to the card, “VALID THRU” may be printed or “MONTH/YEAR” may also be printed. In an embodiment of the present disclosure, the processor 180 may designate a search area in which the expiration date is displayed by using at least one of the above two English notations.

Next, the processor 180 may primarily recognize the expiration date by using a recognition algorithm. As an embodiment of the present disclosure, Cascade Classifier may be used as the recognition algorithm. The processor 180 may extract an expiration date display area of a smaller size than the search area by using the recognition algorithm.

Next, the processor 180 may calculate a candidate area further extended than the primarily recognized area. This process is an additional process for increasing the reliability of the primary recognition.

Finally, the processor 180 may recognize the text in the candidate area by using an artificial intelligence algorithm. For numerical and character recognition, a composite product neural network (CNN), which is one of artificial neural networks that perform deep learning, may be used.

In an embodiment of the present disclosure, the processor 180 may check the recognized expiration date by using a calendar rule. That is, when the expiration date is 5 years, the processor 180 may check the recognized expiration date based on the expiration date that may be expressed at the present time point.

The processor 180 may check whether the recognized expiration date corresponds to a combination of months/years in the range of ‘08/14’ to ‘08/24’ starting from Aug. 7, 2019. If the recognized expiration date is not within the above range, the processor 180 may perform the expiration date re-recognition process by using the image of another grid.

Referring back to FIG. 6, the processor 180 may determine a text display method of the card based on some rules (operation S130). That is, the processor 180 may determine whether the text displayed on the card is embossed or printed by using whether the magnet is present or the array direction of the text and the number of rows.

First, the processor 180 may determine whether a magnet is present in the card area, and determine whether it is the front surface or the rear surface of the card by using the determination result. The recently issued credit card includes not only an IC chip, but also a magnet.

In the credit card, the magnet is often located on the rear surface of the card, and the IC chip is often located on the front surface thereof. Accordingly, when it is determined that the magnet is present in the card image, the corresponding card is most likely a rear card. Further, unlike the traditional front embossed card, the rear card is most likely to display at least one of the card number and the expiration date in printed text.

Further, the processor 180 may determine the array direction of the text by calculating the margin space between the texts, and determine whether the card is vertical or horizontal by using the determination result.

The recently issued vertically designed card is arrayed with the card number in a vertically located state. The array direction of the card number is distinguished from the existing card, and because of the relatively short row length, the card number may not be displayed in one row but may be displayed in a plurality of rows.

Accordingly, when the array direction of the card number in the card image is different from −90 or +90 degrees compared to the conventional one, or when the array of the card number is composed of a plurality of rows, the corresponding card is most likely the vertically designed card. Further, the horizontally designed card is most likely to include the printed text in the card number and the expiration date, unlike the traditional card that are embossed on the front surface thereof.

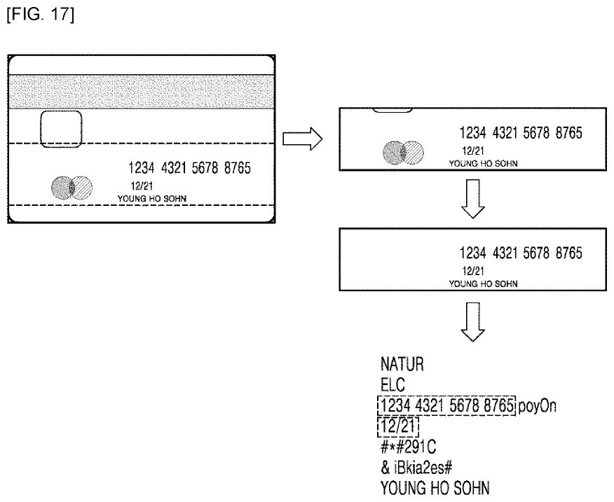

FIG. 17 is an exemplary diagram of a card recognition process having a printed text according to an embodiment of the present disclosure.

Referring to FIG. 17, a process of recognizing printed text is shown. The first figure shows the image of the rear surface of the card, the second figure shows the candidate area, the third figure shows the text recognition result, and the fourth figure shows the display of the card number and the expiration date extracted from the recognition result.

The processor 180 may determine that the input card image is an image of the rear surface through the presence of a magnet. Further, the processor 180 may predict that the corresponding card will include the printed text, and recognize the text by using an algorithm suitable for the printed text recognition.

Referring back to FIG. 17, the processor 180 may set the card area except for the information display area such as the magnet area, the signature bar, and the phone number of the lowest portion in the rear card as a candidate area for detecting the card number.

The processor 180 may preprocess the image for each brightness histogram type of the candidate area so that the printed text may be clearly identified. Here, the preprocessing method used may include thresholding, etc. Accordingly, for the printed text, a preprocessing method is used that is distinguished from the embossed text.

The processor 180 may recognize the full text displayed in the candidate area by using the OCR engine.

Next, the processor 180 may extract the card number and the expiration date that meet the rule from the recognized full text. Referring back to FIG. 17, all 16 digits divided by 4 digit intervals and the expiration date connected by a slash may be extracted as indicated by the dashed rectangular area.

According to an embodiment of the present disclosure, it is possible to distinguish between the card of the embossed text and the card of the printed text, and to recognize the card number by different methods for each card type.

Further, it is possible to recognize both the embossed and printed type card numbers according to the card type at a high recognition rate.

Further, it is possible to prevent a recognition error of the card number in advance by using information on card issuance.

The embodiments of the present disclosure described above may be implemented through computer programs executable through various components on a computer, and such computer programs may be recorded in computer-readable media. For example, the recording media may include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

The singular forms “a,” “an” and “the” in this present disclosure, in particular, claims, may be intended to include the plural forms as well. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Accordingly, it should be understood that the scope of the present disclosure is not limited to the example embodiments described above or by the use of such terms unless limited by the appended claims. Accordingly, it should be understood that the scope of the present disclosure is not limited to the example embodiments described above or by the use of such terms unless limited by the appended claims. Also, it should be apparent to those skilled in the art that various alterations, substitutions, and modifications may be made within the scope of the appended claims or equivalents thereof.

Accordingly, technical ideas of the present disclosure are not limited to the above-mentioned embodiments, and it is intended that not only the appended claims, but also all changes equivalent to claims, should be considered to fall within the scope of the present disclosure.

What is claimed is:

1. A text recognition method, comprising:
recognizing a card number from a card image by performing vertical segmentation and horizontal segmentation,
wherein the horizontal segmentation comprises detecting a width and a location of a digit of the card number through a segmentation using a grid having a variable width based on a configuration pattern of the card number including a size and a number of digits of the card number.

2. The text recognition method of claim 1, further comprises performing a Luhn algorithm check, issuer identification number (IIN) check, a check based on multiple image frames, or a CNN mean confidence check for the recognized card number.

3. A text recognition method, comprising:
detecting a card area in a card image,
wherein the detecting the card area comprises
recognizing an edge of the card; and
extracting the card area based on the recognized edge,
wherein the recognizing the edge of the card comprises:
analyzing a relationship between an upper edge and a lower edge of the card and a relationship between a left edge and a right edge of the card based on the card image; and
determining the edge of the card based on the relationship analysis.

4. The text recognition method of claim 3, wherein in the recognizing the edge of the card, an aspect ratio of the card in the card image is used.

5. A text recognition method, comprising:
determining a text display method of a card from a card image,
wherein the determining the text display method of the card comprises:
determining at least whether the card image is of a front side or a rear side of the card according to presence of a card magnet in the card image, or whether the card image corresponds to a landscape or portrait orientation of the card based on a text array direction using a margin space calculation between texts; and
predicting the text display method of the card based on the determination.

6. The text recognition method of claim 5, wherein the determining the text display method of the card further comprises determining the text display method of the card between an embossing method and a printing method.

7. The text recognition method of claim 6, further comprising recognizing a card number and an expiration date from the card image,
wherein when it is determined that the text display method of the card is the embossing method, the recognizing the card number and the expiration date comprises:
extracting information on at least a card company or an issuer through a card number recognition;
detecting an expiration date type for a particular card company or issuer based on the extracted information and a previously stored database; and
checking the expiration date by using the expiration date type.

8. The text recognition method of claim 6, further comprising recognizing a card number and an expiration date from the card image,
wherein when it is determined that the text display method of the card is the printing method, the recognizing the card number and the expiration date comprises:
setting a candidate area based on the determination of whether the card image is of the front or rear side or whether the card image corresponds to the portrait or landscape orientation of the card;
recognizing a text in the candidate area through an optical character recognition (OCR); and
predicting the card number by using the recognized text and the expiration date based on a detected slash.

9. The text recognition method of claim 5, further comprising preprocessing the card image in order to recognize text overlapping an image background.

10. The text recognition method of claim 5, further comprising:
displaying a menu for selecting a portrait type card or a landscape type card for processing a card image; and
receiving an input card image according to the portrait type card or the landscape type card according to a user selection on the displayed menu.

11. A text recognition apparatus, comprising:
a camera;
a display; and
a processor configured to:
capture a card image of a card via the camera and display the card image via the display;
recognizing a card number of the card based on the card image, wherein the card number is recognized by performing vertical segmentation and horizontal segmentation,
wherein the processor is further configured to detect a width and a location of a digit of the card number through vertical segmentation using a grid having a variable width based on a configuration pattern of the card number including a size and a number of digits of the card number.

12. The text recognition apparatus of claim 11, wherein the processor is further configured to perform a Luhn algorithm check, issuer identification number (IIN) check, a check based on multiple image frames, or a CNN mean confidence check for the recognized card number.

13. A text recognition apparatus, comprising:
a camera;
a display; and
a processor configured to:
capture a card image of a card via the camera and display the card image via the display;
detect a card area using the card image by recognizing an edge of the card and extracting the card area based on the recognized edge; and
wherein the processor is configured to recognize the edge of the card by analyzing a relationship between an upper edge and a lower edge of the card and a relationship between a left edge and a right edge of the card based on the card image, and
wherein the processor is further configured to determine the edge of the card based on the relationship analysis.

14. The text recognition apparatus of claim 13, wherein the processor is further configured to recognize the edge of the card by using an aspect ratio of the card in the card image.

15. A text recognition apparatus, comprising:
a camera;
a display; and
a processor configured to:
capture a card image of a card via the camera and display the card image via the display;
determine at least whether the card image is of a front side or a rear side of the card according to presence of a card magnet in the card image, or whether the card image corresponds to a landscape or portrait orientation of the card based on a text array direction using a margin space calculation between texts; and
predict a text display method of a card based on the determination.

16. The text recognition apparatus of claim 15, wherein the processor is further configured to determine the text display method of the card between an embossing method and a printing method.

17. The text recognition apparatus of claim 16, wherein the processor is further configured to:
extract information on at least a card company or an issuer through a card number recognition;
detect an expiration date type for a particular card company or issuer based on the extracted information and a previously stored database;
check an expiration date by using a database on an expiration date type for each card company and issuer previously prepared based on the recognized card number when the text display method of the card is determined to be the embossing method.

18. The text recognition apparatus of claim 16, wherein the processor is further configured to:
set a candidate area based on the determination of whether the card image is of the front or rear side or whether the card image corresponds to the portrait or landscape orientation of the card;
recognize a text in the candidate area through an optical character recognition (OCR); and
predict a card number by using the recognized text and an expiration date based on a detected slash.

19. The text recognition apparatus of claim 15, wherein the processor is further configured to perform a card image preprocessing in order to recognize text overlapping an image background.

20. A text recognition apparatus, comprising:
a camera;
a display; and
a processor configured to:
display a menu via the display for selecting a portrait type card or a landscape type card for processing the card image; and
receiving an input card image captured via the camera according to the portrait type card or the landscape type card according to a user selection on the displayed menu.
